(19) United States
(12) Patent Application Publication
(10) Pub. No.: US 2011/0036379 A1
(43) Pub. Date: Feb. 17, 2011

(54) CLEANING DEVICE

(75) Inventor: Robert Auer, Stadtbergen (DE)

Correspondence Address: Fleit Gibbons Gutman Bongini & Bianco PL, 21355 EAST DIXIE HIGHWAY, SUITE 115, MIAMI, FL, 33180, US

(73) Assignee: WashTec Holding GmbH, Augsburg (DE)

(21) Appl. No.: 12/918,176

(22) PCT Filed: Feb. 16, 2009
(86) PCT No.: PCT/EP2009/051805

§ 371 Date: Oct. 7, 2010

(30) Foreign Application Priority Data
Feb. 20, 2008 (DE) 102008010223.7

(51) Int. Cl. B05B 12/00; H02J 7/00

(52) U.S. Cl. 134/115 R; 320/108

(57) ABSTRACT

The invention relates to a cleaning device (1) with a cleaning lance (3) and a holding device (2) for housing the cleaning lance (3), said holding device containing a rechargeable electric energy storage device (9a) for providing electrical users of the cleaning lance (3) and a charging device (9b) for charging the energy storage device (9a). The invention solves the objective of providing the cleaning lance with electrical energy reliably and in a simple manner, in that the cleaning device (1) comprises an electrical energy transfer unit (11) for non-contact transferring of electrical energy between the holding device (2) and the charging device (9b) for charging the energy storage device (9a).

The invention pertains to a cleaning device according to the preamble of claim 1.

In self-service car wash installations (SB car wash installations), car owners clean their cars themselves such that no operating personnel is required. The cleaning of the car is usually carried out with a generally known cleaning lance, for example, according to DE 698 12 064 T2. In a first step, a cleaning fluid that usually consists of water mixed with washing chemicals is sprayed onto the car surfaces with the cleaning lance. After a brief exposure time, the cleaning fluid is sprayed off the car surfaces with softened water that is ejected from the cleaning lance under high pressure such that soaked dirt particles are also removed. The selection and the display of the washing program, as well as the initiation and the display of the individual washing steps, are usually realized on a central automatic control, into which coins can be inserted in order to start the washing process. In order to respectively adjust the next washing step, the user needs to walk to the automatic control regardless of where he is currently located.

In order to eliminate this disadvantage, cleaning devices have been proposed, in which the display and the adjustment of washing parameters and washing steps are realized on the cleaning lance itself. For this purpose, the cleaning lance features electronics that operate a display and transmit entered commands to the control of the car wash installation or receive signals therefrom via corresponding cables or in a wireless fashion. This simplifies the operation of the cleaning device and the washing process can be carried out faster and without having to inconveniently walk back to the automatic control. However, one problem in cleaning lances of this type is the supply of the electronics in the cleaning lance with electrical energy.

One commonly used solution for realizing this energy supply is the use of batteries or accumulators in the cleaning lance. For example, DE 27 24 283 A1 discloses a spraying device for cleaning apparatuses, in which a transmitter provided on the spraying device is supplied by a battery or accumulator arranged in the spraying device.

In the spray gun according to DE 103 06 660 D3, a radio transmitter in the spray gun is supplied with energy by a battery.

EP 1 281 444 A1 discloses a fluid delivery device for a high-pressure cleaning apparatus with a handheld spray gun. A pressure sensor arranged in the handheld spray gun serves for measuring the pressure of the cleaning fluid flowing in the fluid line of the spray gun, wherein said pressure sensor features, among other things, an electric sensing element, an assigned electric circuit and a pressure display unit. In order to supply these components with electrical energy, a replaceable battery is assigned thereto.

EP 1 426 049 B1 discloses a safety cleaning lance with a safety device that features a touch-sensitive sensor on the handle of the safety cleaning lance. The sensor detects whether the handle is held by the hand of a user. This safety device is supplied by means of an energy supply in the form of batteries or accumulators arranged in the handle part of the cleaning lance. A charge monitoring device for the energy supply generates an alarm signal if the charge falls short of a predetermined minimum charge and prevents the cleaning lance from being used or switches off the cleaning lance during its operation. The maintenance personnel is informed of the required battery or accumulator replacement by this alarm signal.

DE 203 07 272 U1 discloses a high-pressure spray gun with a valve for opening and closing a fluid outlet, wherein the valve can be actuated by means of an electric drive. The electric drive is supplied with electrical energy by an accumulator that can be attached to the handle part. The accumulator can be replaced if its voltage or capacity drops below a predetermined limiting value.

All these known cleaning lances have the disadvantage that the state of charge of the batteries or accumulators no longer suffices for supplying the electrical energy required for the operation of the cleaning lance after a certain period of time. Whenever this occurs, the batteries or accumulators usually need to be replaced by the operating personnel of the car wash installation. The spray guns feature an externally accessible battery compartment for this purpose. Due to the moist environment, in which the cleaning lances used, this battery compartment needs to be realized in a moisture-proof fashion so as to reliably prevent the admission of moisture during the operation of the cleaning lance and the resulting corrosion and short circuits in the electric and electronic units of the cleaning lance. It is also important that no moisture or fluid is admitted into the battery compartment when the battery is replaced.

The cleaning lances are used almost continuously, particularly in the evenings or on Saturdays when many car owners wash their cars, such that the batteries or accumulators are strained and may have to be replaced. This means that the operator of the car wash installation needs to hire operating personnel, but this is undesirable in SB car wash installations. However, the operator of the car wash installation may have to accept a significant loss of revenue if the operation of the car wash installation is interrupted because discharged batteries or accumulators are not replaced.

As a solution to this problem, EP 1 526 049 B1 proposes to use batteries that have a service life of 5-10 years and therefore can be cast into the handle of the cleaning lance. Once the batteries are depleted after this time period, the entire electronics unit of the cleaning lance is replaced. This means that the cleaning lance fails entirely and a replacement lance or at least a replacement electronics unit always needs to be kept on hand. In addition, such long-life batteries are very expensive.

In order to overcome the disadvantages associated with the battery replacement, DE 41 05 614 C1 proposes to realize a battery contained in the spray gun in a rechargeable fashion, wherein a generator for generating a battery charging voltage is also situated in the spray gun and driven by the fluid flowing through the spray gun. In this case, it is possible, for example, to utilize the kinetic flow energy for moving a generator, the pressure fluctuations of the fluid for a direct voltage generation or for moving components that drive the generator, the temperature of the fluid and other physical effects that make it possible to obtain energy for generating an electric supply voltage for the battery from the flowing fluid jet. The energy generated in the spray gun usually suffices for supplying, for example, a high-frequency transmitter or the like with a voltage. This means that the spray gun is not dependent on an external voltage supply. However, one disadvantage of this solution can be seen in the fact that the battery can only be charged during the relatively short periods of time, during which the spray gun is in operation. This means that the battery is not charged if the spray gun is not used for an extended period of time such as, for example, on Sundays and holidays. If the state of charge of the battery drops below the level required for the operation of the electrical units of the spray gun, e.g., due to self-discharge at very low temperatures, the spray gun is no longer able to operate such that the battery also can no longer be charged.

It is also common practice in the state of the art to design the accumulators of electrically operated handheld equipment such as lawnmowers, cordless screwdrivers (US 2006/0087282), electric toothbrushes (DE 26 08 458 A1), mobile telephones (DE 10 2005 045 360 A1) or barcode scanners (U.S. Pat. No. 5,070,293) in an externally rechargeable fashion. However, the devices disclosed in these publications are related to special fields that significantly differ from the special field of cleaning devices in car wash installations. In the field of car wash installations, the requirements clearly differ from the aforementioned known applications, in particular, with respect to zero maintenance, high level of availability, reliability, robustness during handling and encapsulation against the moist environment of a cleaning device.

The invention therefore is based on the objective of overcoming the above-described disadvantages and of developing a cleaning device that ensures the supply of the cleaning lance with electrical energy in a reliable and simple fashion.

According to the invention, this objective is attained with a cleaning device with the characteristics of claim 1. Advantageous embodiments and practical additional developments of the invention are disclosed in the dependent claims.

The inventive cleaning lance is characterized in that the cleaning device features an electrical energy transfer unit for the contactless, particularly inductive, transfer of electrical energy between the holding device and the charging device of the cleaning lance in order to charge the energy storage device. Due to these measures, the energy storage device, preferably an accumulator, can always be charged when the lance is not an operation. This makes it possible to easily manage extended standstill periods without risking an excessive drop of the charge of the energy storage device. In the present context, the term energy transfer should be interpreted in the sense of power engineering, in which the highest energy or power possible should be transferred with a high utilization factor, and not in the sense of communication engineering, in which the best signal transmission possible should be achieved. Consequently, the known radio transmission in cleaning lances would not make it possible to provide the energy required for charging the accumulator of the cleaning lance.

According to one advantageous embodiment of the invention, the energy transfer unit consists of a transformer with a primary wire-wound coil arranged on the holding device and a secondary wire-wound coil arranged on the cleaning lance. The primary and/or secondary wire-wound coils are advantageously cast into a plastic housing such that they are robust and protected from moisture. A preferred embodiment of the invention may feature a coupling device that holds the cleaning lance inserted into the holding device in a coupling position, in which an adequate magnetic coupling exists between the primary wire-wound coil and the secondary wire-wound coil. This ensures an effective energy transfer and therefore fast and low-loss charging of the energy storage device. In a particularly space-saving variation of the coupling device, this coupling device comprises the primary wire-wound coil and/or the secondary wire-wound coil.

One practical embodiment of the coupling device features a first stop on the holding device and a second stop on the cleaning lance, wherein the stops hold the cleaning lance in the coupling position in the holding device. This makes it possible to ensure an adequate magnetic coupling with simple means. A very compact coupling device can be realized if the first stop is formed by the primary wire-wound coil and the second stop is formed by the secondary wire-wound coil.

In an additional development of the cleaning device, an insertion aid is provided for inserting the cleaning lance into the coupling position in the holding device. This ensures that the user can reliably and quickly insert the cleaning lance into the coupling position after it has been used. This even applies if the energy transfer device of the coupling device is encased or integrated into the cleaning lance. In this case, the user is indirectly instructed or forced to move the cleaning lance into the coupling position such that the charging process can be ensured.

Such an insertion aid can be advantageously realized by designing the first stop of the coupling device in the form of an internal cone segment that narrows in the inserting direction of the cleaning lance and the second stop in the form of an external cone segment that is tapered in the inserting direction, wherein the larger diameter of the external cone segment is larger than the smaller diameter of the internal cone segment. However, the insertion aid may also be realized differently, e.g., in the form of an inserting region of the holding device that is shaped like a funnel or downwardly tapered in a conical fashion.

The cleaning device is not only suitable for use in car wash installations, but can also be advantageously utilized in other applications, in which a fluid is sprayed from a cleaning lance or a similar device that contains an independent energy supply, for example pressure washers.

Other features and advantages of the invention result from the following description of one preferred exemplary embodiment that refers to the enclosed drawings. In these drawings:

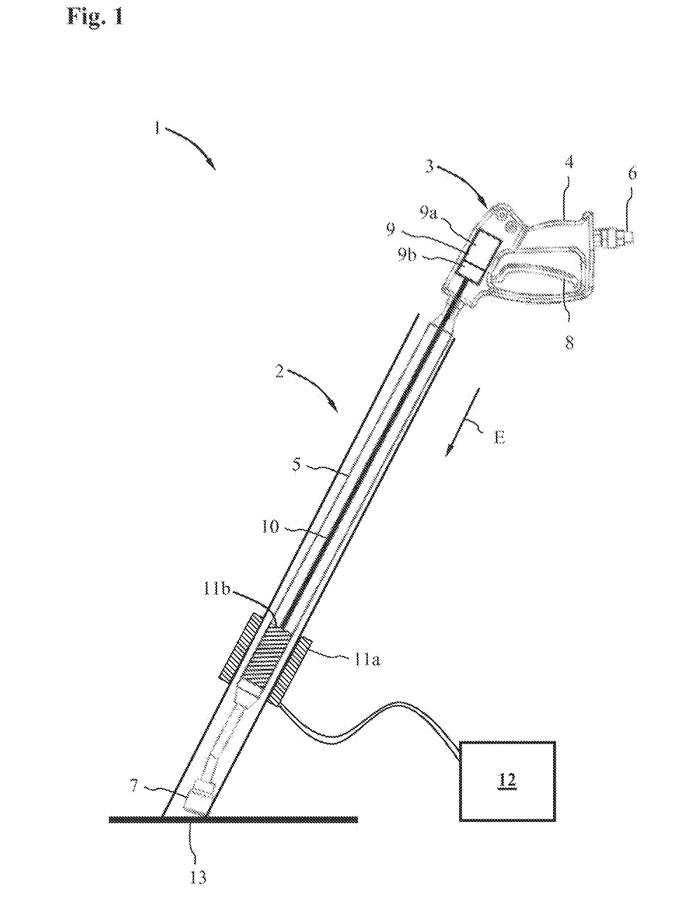

FIG. 1 shows a schematic section through an inventive cleaning device with a cleaning lance;

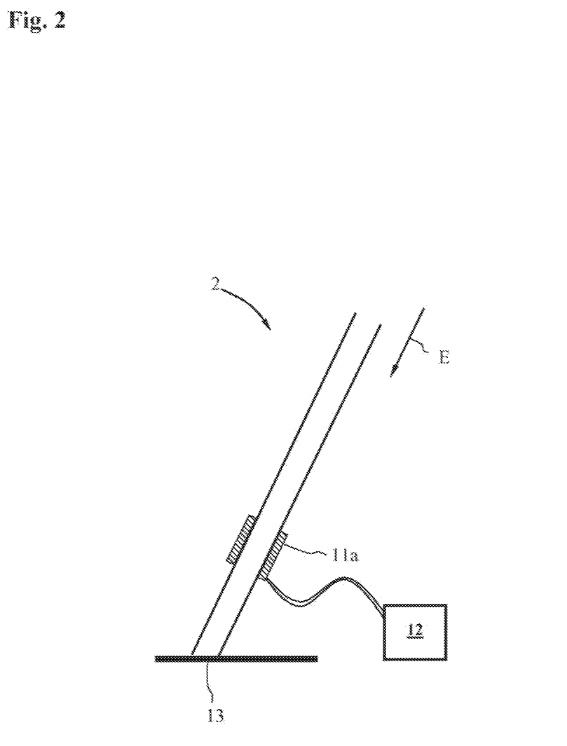

FIG. 2 shows the cleaning lance;

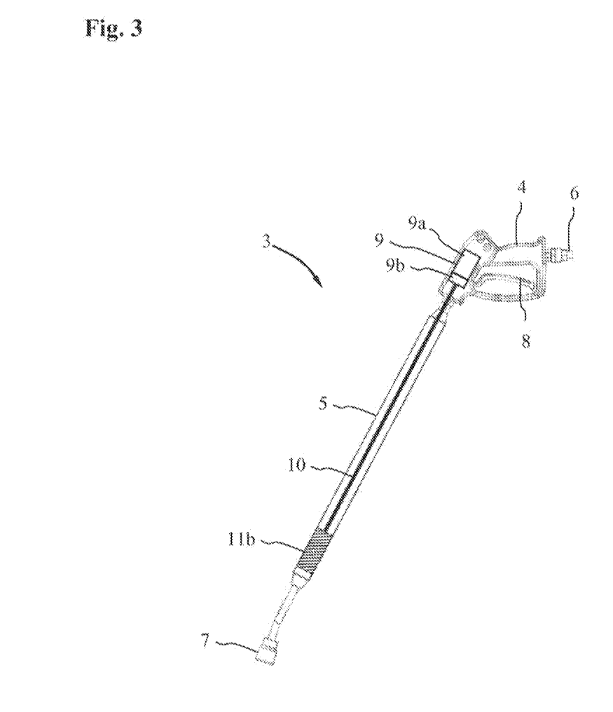

FIG. 3 shows a holding device of the cleaning device according to FIG. 1;

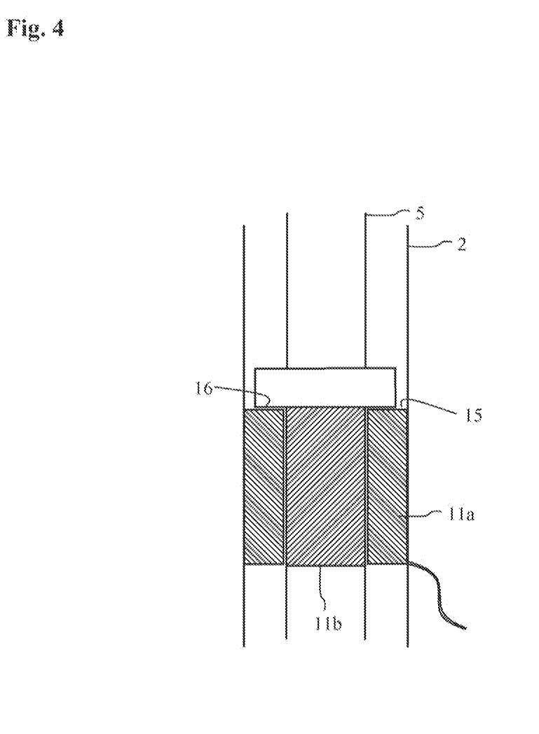

FIG. 4 shows a detail of a first embodiment of the coupling device of the inventive cleaning device;

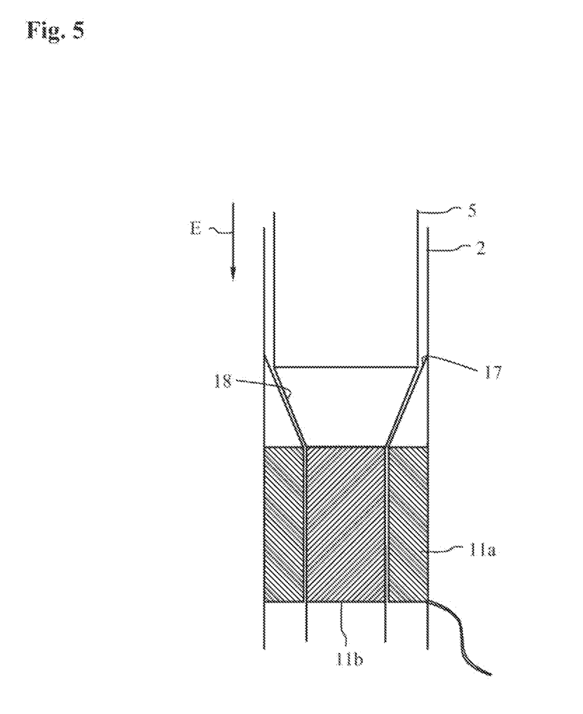

FIG. 5 shows a detail of a second embodiment of the coupling device;

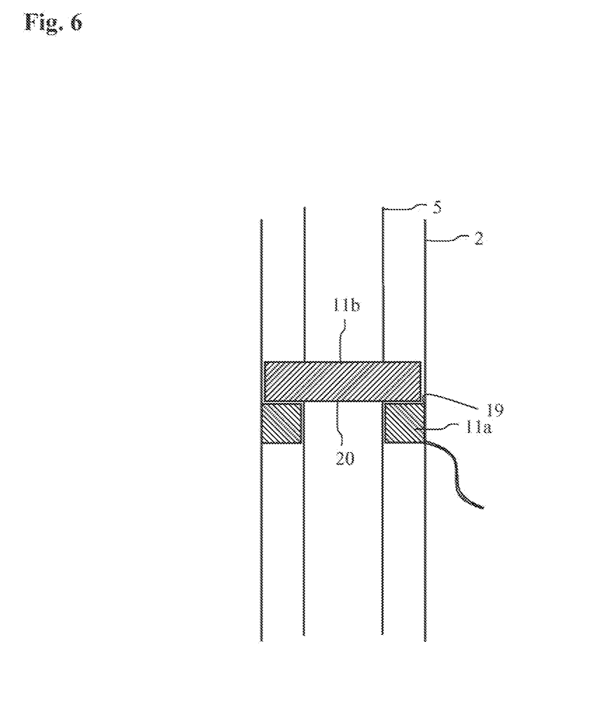

FIG. 6 shows a detail of a third embodiment of the coupling device, and

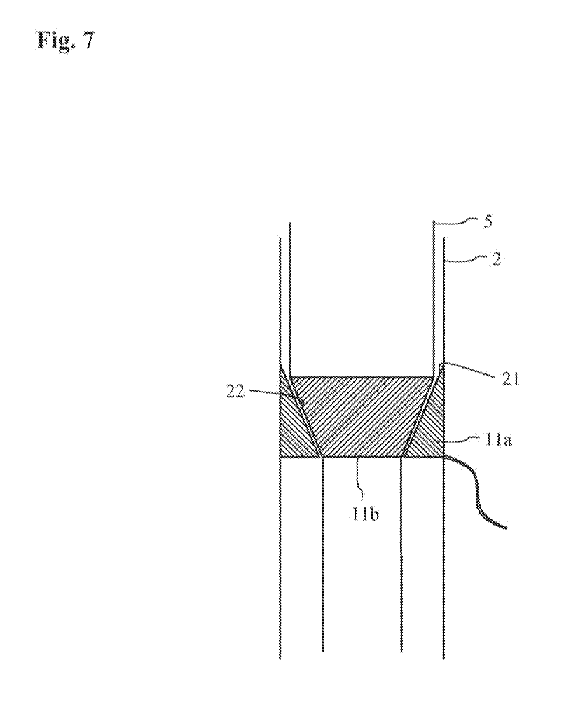

FIG. 7 shows a detail of a fourth embodiment of the coupling device.

FIG. 1 shows an inventive cleaning device 1 with a tubular holding device 2 for a cleaning lance 3. In the unused state, the cleaning lance 3 is inserted into the holding device 2 in the inserting direction E and stored therein. As an alternative to the holding device 2 in the form of a long closed tube shown in the figure, it would also be possible to realize the holding device 2 in the form of a short and/or partially open tube or in the form of a clip-on holder. The holding device 2 may also be arranged vertically or with an incline other than that shown in FIG. 1. In a design in the form of a clip-on holder, the cleaning lance 3 can be laterally clipped into the holding device 2.

With respect to its design and construction, the cleaning lance 3 illustrated in FIG. 2 essentially corresponds to known cleaning lances with a handle 4 and a lance-shaped jet tube 5. The handle 4 is connected to a not-shown hose with a pump unit by means of a high-pressure connection 6. A cleaning nozzle 7 arranged on the front end of the jet tube 5 makes it possible to spray water and cleaning fluid supplied by the pump unit onto the car surfaces to be washed, if applicable, also under high pressure. The fluid discharge of the cleaning lance 3 can be released or blocked by means of a trigger 8.

An energy supply unit 9 is provided in the cleaning lance 3 in order to supply electrical consumers arranged in the handle 4 of the cleaning lance 3 such as, for example, a pressure indicator, a selection device, a transmitting/receiving unit or a safety monitoring device with electrical energy, wherein said energy supply unit contains an electrical energy storage device in the form of a rechargeable accumulator 9a and a charging device 9b therefor.

In order to charge the accumulator 9a, the charging device 9b is connected to a secondary wire wound coil 11b on the front end of the lance section 5 via a line 10. The secondary wire-wound coil 11b and a primary wire-wound coil 11a arranged on the holding device 2 jointly form a contactless electrical energy transfer unit in the form of a transformer 11. The primary wire-wound coil 11a is supplied with electrical energy, in this case an alternating voltage, by an electrical energy supply unit 12. The primary wire-wound coil 11a and the secondary wire-wound coil 11b are both wound on a core that conducts the magnetic field lines, in this case an annular iron core, and protected from the surroundings by a casing or housing. The wire-wound coils 11a and 11b may also be respectively cast into a plastic housing.

The charging of the accumulator 9a by means of the charging device 9b and the transformer 11 takes place when the cleaning lance 3 is inserted into the holding device 2 as shown in FIG. 1. In this coupling position, the primary wire-wound coil 11a encompasses the secondary wire-wound coil 11b arranged on the cleaning lance 3. In order to ensure the best magnetic coupling possible between the wire-wound coils 11a and 11b of the transformer 11, the cleaning nozzle 7 stands on the bottom 13 of the holding device 2 in the exemplary embodiment shown. The wire-wound coils 11a and 11b therefore are situated in the immediate vicinity of one another such that an adequate magnetic coupling is achieved.

In an alternative embodiment of the cleaning device 1, a coupling device 14 is provided which ensures that the wire-wound coils 11a, 11b are held relative to one another in a spatial coupling position of the cleaning lance 3 inserted into the holding device 2 that is optimal with respect to the magnetic coupling. Different variations of the coupling device 14 are illustrated in FIGS. 4-7. Only the decisive differences between the coupling devices 14 are described below. Components that are identical to those described with reference to the preceding embodiments and drawings are identified by the same reference symbols.

In FIG. 4, the primary wire-wound coil 11a is annularly arranged on the inner wall of the tubular holding device 2 and forms a stop 15 in the shape of a circular ring on its insertion end. The secondary wire-wound coil 11b on the jet tube 5 is identical to that described above. A stop 16 in the shape of a circular ring is arranged on the jet tube 5 directly above the secondary wire-wound coil 11b, wherein the outside diameter of said stop is larger than the inside diameter of the primary wire-wound coil 11a or its casing, respectively. In the inserted state, the stop 16 of the secondary wire-wound coil 11b consequently lies on the stop 15 of the primary wire-wound coil 11a. This ensures that the wire-wound coils 11a and 11b are spatially arranged as close as possible to one another in the coupling position so as to ensure the best magnetic coupling and therefore the best inductive electrical energy transfer possible.

In FIG. 5, the wire-wound coils 11a, 11b are realized identical to those illustrated in FIG. 4. The coupling device 14 features a stop in the form of an internal cone segment 17 that narrows inward in the inserting direction E of the cleaning lance 3 on the holding device 2. The jet tube 5 features an external cone segment 18 that is adapted to the conical internal cone segment 17 directly above the secondary wire-wound coil 11a. Due to the corresponding internal and external cone shapes, the internal cone segment 17 and the external cone segment 18 form an additional insertion aid in order to reliably insert the cleaning lance 2 and therefore the jet tube 5 into the favorable coupling position for the magnetic coupling shown in the figure.

In the coupling device 14 illustrated in FIG. 6, the primary wire-wound coil 11a is arranged on the inner wall of the tubular holding device 2 in the shape of a circular ring and simultaneously forms a stop 19 in the shape of a circular ring on the insertion side. The secondary wire-wound coil 11b annularly encompasses the jet tube 5 and simultaneously forms a stop 20 in the shape of a circular ring with an outside diameter that is larger than the inside diameter of the primary wire-wound coil 11a. In the coupling position of the cleaning lance 3, the stop 20 lies on the stop 19 of the primary wire-wound coil 11a. This design has relatively small dimensions, but ensures an adequate magnetic coupling. Existing cleaning devices can also be easily retrofitted.

Analogous to the embodiment illustrated in FIG. 6, the coupling device 14 of the embodiment according to FIG. 7 is also formed by the wire-wound coils 11a and 11b. This embodiment essentially can be distinguished from the embodiment shown in FIG. 5 in that the wire-wound coil 11a is realized in the form of an internal cone 21, wherein this internal cone forms a stop that narrows inward in the inserting direction E, and in that the secondary wire-wound coil 11a is integrated into an external cone segment 22 of the jet tube 5 that serves as a stop. In addition to the advantages achieved with the embodiment illustrated in FIG. 5, this embodiment has a design that saves space and material.

Since the user of the cleaning lance 3 usually re-inserts the cleaning lance into the holding device 2 after its use, it can be easily ensured that the accumulator 9b is charged, particularly when the cleaning lance 3 is not used over extended periods of time. If the wire-wound coils 11a and/or 11b are cast into a plastic housing, the stops 16, 19, 20, 21 and 22 can be realized in a particularly simple fashion, but are still robust and protected from moisture.

1. A cleaning device (1) with a cleaning lance (3) and a holding device (2) for storing the cleaning lance (3), wherein said cleaning device contains a rechargeable electrical energy storage device (9a) for supplying electrical consumers of the cleaning lance (3) and a charging device (9b) for charging the energy storage device (9a), wherein the cleaning device (1) features an electrical energy transfer unit (11) for the contactless transfer of electrical energy between the holding device (2) and the charging device (9b) in order to charge the energy storage device (9a).

2. The cleaning device (1) according to claim 1, wherein the energy transfer unit (11) consists of a transformer with a primary wire-wound coil (11a) arranged on the holding device (2) and a secondary wire-wound coil (11b) arranged on the cleaning lance (3).

3. The cleaning device (1) according to claim 1, wherein the holding device (2) features a tube for inserting an elongated jet tube (5) of the cleaning lance (3).

4. The cleaning device (1) according to claim 3, wherein the tube of the holding device (2) downwardly narrows in a conical fashion.

5. The cleaning device (1) according to claim 1, wherein a coupling device (14) holds the cleaning lance (3) inserted into the holding device (2) in a coupling position, in which a sufficient magnetic coupling for charging the energy storage device (11) exists between the holding device (2) and the charging device (9b).

6. The cleaning device (1) according to claim 5, wherein the primary wire-wound coil (11a) and the secondary wire-wound coil (11b) are arranged in close spatial vicinity of one another in the coupling position.

7. The cleaning device (1) according to claim 5, wherein the coupling device (14) contains the primary wire-wound coil (11a) and/or the secondary wire-wound coil (11b).

8. The cleaning device (1) according to claim 4, wherein the coupling device (14) features a first stop on the holding device (2) and a second stop (16; 18; 20; 22) on the cleaning lance (3), and by the fact that the stops (16, 17; 18, 19; 20, 21; 22, 23) hold the cleaning lance (3) in the coupling position in the holding device (2).

9. The cleaning device (1) according to claim 8, wherein the first stop (19; 21) is formed by the primary wire-wound coil (11a) and/or the second stop (20; 22) is formed by the secondary wire-wound coil (11b).

10. The cleaning device (1) according to claim 9, wherein the first stop (15; 19) and the second stop (16; 20) are realized in the shape of a circular ring, wherein the inside diameter of the first stop (15; 19) is smaller than the outside diameter of the second stop (16; 20).

11. The cleaning device (1) according to claim 9, wherein the first stop is realized in the form of an internal cone segment (17; 21) that narrows in the inserting direction (E) of the cleaning lance (3) and the second stop is realized in the form of an external cone segment (18; 22) that is tapered in the inserting direction (E), wherein the larger diameter of the external cone segment (18; 22) is larger than the smaller diameter of the internal cone segment (17; 21).

12. The cleaning device (1) according to claim 1, wherein an insertion aid (17, 18; 21, 22) is provided for inserting the cleaning lance (3) into the coupling position in the holding device (2).
